(19) United States
(12) Patent Application Publication
(10) Pub. No.: US 2016/0078895 A1
(43) Pub. Date: Mar. 17, 2016

(54) SPINDLE MOTOR AND HARD DISK DRIVE INCLUDING THE SAME

(71) Applicant: SAMSUNG ELECTRO-MECHANICS CO., LTD., Suwon-Si (KR)

(72) Inventor: Dong Hyun LEE, Suwon-Si (KR)

(73) Assignee: SAMSUNG ELECTRO-MECHANICS CO., LTD., Suwon-Si (KR)

(21) Appl. No.: 14/660,458

(22) Filed: Mar. 17, 2015

(30) Foreign Application Priority Data
Sep. 11, 2014 (KR) 10-2014-0120462

(51) Int. Cl. G11B 19/20; H02K 7/08

(52) U.S. Cl. CPC G11B 19/2036; H02K 7/086

(57) ABSTRACT

A spindle motor includes a stator, and a rotor forming a bearing clearance filled with a lubricating fluid, together with the stator. At least one of the rotor and the stator is provided with a circulation hole through which air bubbles contained in the lubricating fluid are discharged, and a portion of the bearing clearance connected to one end portion of the circulation hole and disposed at an outer side of the circulation hole in a radial direction has a width allowing an amount of force applied to the other side of the air bubble to be less than that of force applied to one side of the air bubble when one side of the air bubble is disposed in the circulation hole and the other side thereof is disposed in the portion of the bearing clearance connected to the circulation hole.

### CROSS-REFERENCE TO RELATED APPLICATION

This application claims the priority and benefit of Korean Patent Application No. 10-2014-0120462 filed on Sep. 11, 2014, with the Korean Intellectual Property Office, the disclosure of which is incorporated herein by reference.

### BACKGROUND

The present disclosure relates to a spindle motor and a hard disk drive including the same.

Generally, a small-sized spindle motor used in a hard disk drive (HDD) serves to rotate a disk so that a magnetic head may write data to the disk or read data written on the disk.

In addition, the spindle motor may be provided with a bearing clearance filled with a lubricating fluid, the lubricating fluid filling the bearing clearance supporting a rotor at the time of rotation of the rotor while being pressurized.

Meanwhile, a level of pressure lower than atmospheric pressure, that is, negative pressure, may be generated in the bearing clearance at the time of the rotation of the rotor. A circulation hole may be formed in the spindle motor for preventing the generation of negative pressure to decrease the generation of the negative pressure and move air bubbles generated at the time of the generation of the negative pressure, thereby allowing the air bubbles to be discharged to externally.

However, in the case in which air bubbles are introduced into the bearing clearance by external impacts, air bubbles having a size larger than a diameter of the circulation hole may be introduced into the circulation hole.

In this case, the air bubbles introduced into the circulation hole may be confined in one end of the circulation hole to hinder circulation of the lubricating fluid and raise an interface of the lubricating fluid, thereby allowing the lubricating fluid to be leaked externally.

### RELATED ART DOCUMENT

(Patent Document 1) Korean Patent Laid-Open Publication No. 2014-0080839

### SUMMARY

An aspect of the present disclosure may provide a spindle motor capable of easily discharging air bubbles, and a hard disk drive including the same.

According to an aspect of the present disclosure, a spindle motor may include a stator, and a rotor forming a bearing clearance filled with a lubricating fluid, together with the stator, wherein at least one of the rotor and the stator is provided with a circulation hole through which air bubbles contained in the lubricating fluid are discharged, and a portion of the bearing clearance connected to one end portion of the circulation hole and disposed at an outer side of the circulation hole in a radial direction has a width allowing an amount of force applied to the other side of the air bubble to be less than an amount of force applied to one side of the air bubble when one side of the air bubble is disposed in the circulation hole and the other side of the air bubble is disposed in a portion of the bearing clearance connected to the circulation hole.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic cross-sectional view showing a spindle motor according to an exemplary embodiment of the present disclosure;

FIG. 2 is an enlarged view of part A of FIG. 1;

FIG. 3 is a view for describing a state in which air bubbles are introduced into a circulation hole of the spindle motor according to an exemplary embodiment of the present disclosure;

FIGS. 4 through 7 are views for describing an operation of the spindle motor according to an exemplary embodiment of the present disclosure; and

FIG. 8 is a schematic cross-sectional view showing a hard disk drive according to an exemplary embodiment of the present disclosure.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

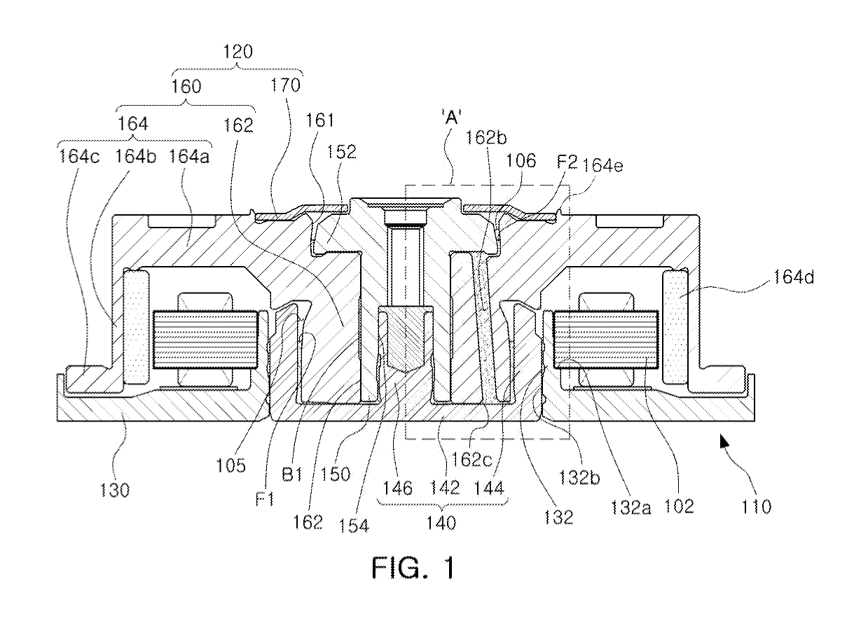

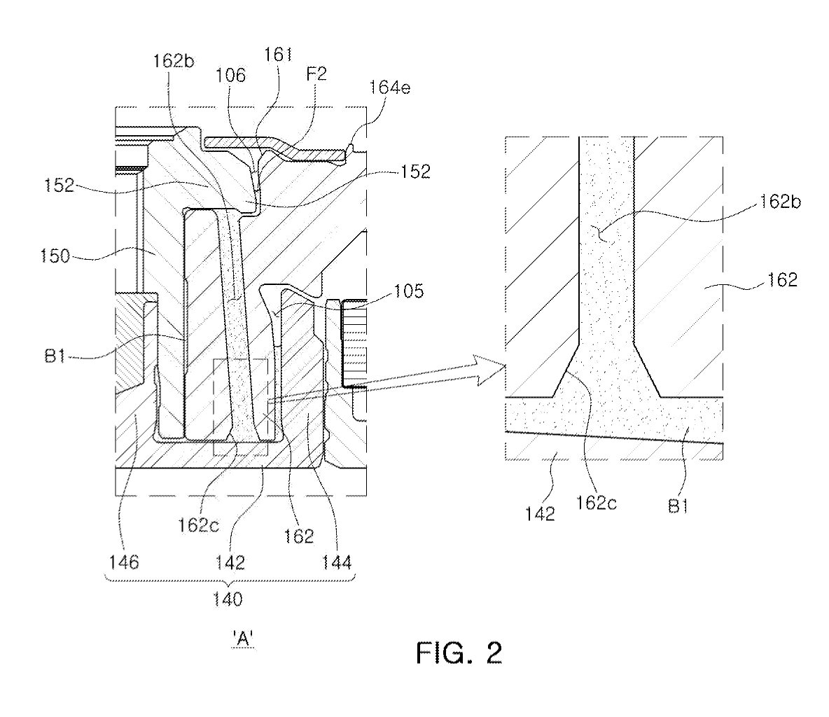

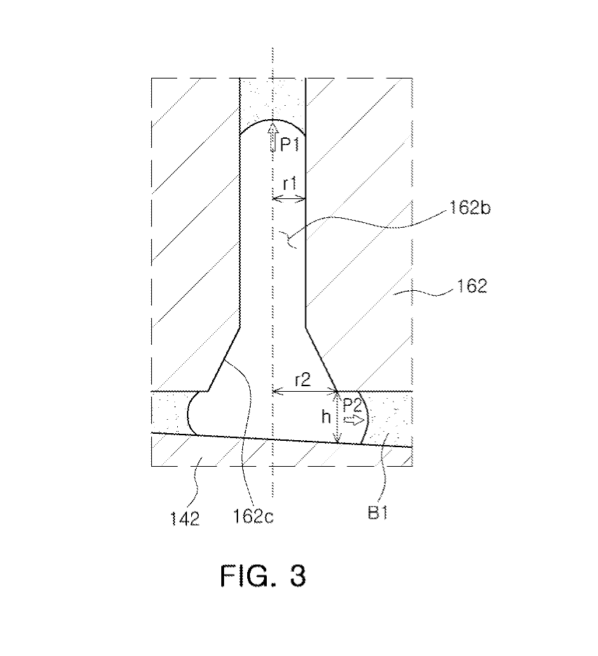

FIG. 1 is a schematic cross-sectional view showing a spindle motor according to an exemplary embodiment of the present disclosure; FIG. 2 is an enlarged view of part A of FIG. 1; and FIG. 3 is a view for describing a state in which air bubbles are introduced into a circulation hole of the spindle motor according to an exemplary embodiment of the present disclosure.

Referring to FIGS. 1 through 3, a spindle motor 100 according to an exemplary embodiment of the present disclosure may include a stator 110 and a rotor 120.

Meanwhile, the spindle motor 100 according to an exemplary embodiment of the present disclosure may be, for example, a motor used in an information recording and reproducing device such as a hard disk drive to be described below, or the like.

The stator 110 may include a base member 130, a lower thrust member 140, and a shaft 150.

The base member 130 may include an installation part 132 on which a stator core 102 is installed. That is, the installation part 132 may have the stator core 102 bonded to an outer peripheral surface thereof. To this end, the installation part 132 may have a support surface 132a formed in order to support a lower surface of the stator core 102. As an example, the stator core 102 may be fixed to the installation part 132 to be seated on the support surface 132a of the installation part 132. Here, the stator core 102 may be bonded to the installation part 132 by at least one of a press-fitting method and an adhesion method.

Meanwhile, although the case in which the stator core 102 is installed on the installation part 132 of the base member 130 has been described by way of example in the present exemplary embodiment, the present disclosure is not limited thereto. That is, the stator core 102 may also be installed on a separate installation member.

Further, the lower thrust member 140 may be fixed to an inner surface of the installation part 132. That is, the lower thrust member 140 may be inserted into an installation hole 132b formed by the installation part 132.

The lower thrust member 140 may be inserted into the installation part 132 and be fixed to the installation part 132, as described above. As an example, the lower thrust member 140 may be fixed to the installation part 132 by at least one of an adhering method, a press-fitting method, and a welding method.

Meanwhile, the lower thrust member 140 may include a disk part 142 having a disk shape, a sealing wall part 144 extended from an edge of the disk part 142 in an upward axial direction, and a coupled part 146 extended from a central portion of the disk part 142 in the upward axial direction and coupled to the shaft 150.

In addition, the lower thrust member 140 may form a bearing clearance B1 in which a lubricating fluid is filled, together with a rotating member 160 of a rotor 120 to be described below. In addition, the sealing wall part 144 may forma sealing part 105 in which an interface (that is, a liquid-vapor interface F1) between the lubricating fluid and air is formed, together with the rotor 120, as shown in FIG. 2.

Meanwhile, an upper surface of the disk part 142 of the lower thrust member 140 may be inclined. That is, the upper surface of the disk part 142 may be inclined so that a width of a bearing clearance formed by the upper surface of the disk part 142 and a facing surface of the rotating member 160 disposed to face the upper surface of the disk part 142 becomes wide in an outer diameter direction.

A detailed description therefor will be provided below.

The shaft 150 may have a lower end portion fixed to the lower thrust member 140 and include a flange part 152 formed at an upper end portion thereof.

As an example, a coupling groove 154 into which the coupled part 146 of the lower thrust member 140 is inserted may be formed at the lower end portion of the shaft 150, and the coupled part 146 may be inserted into the coupling groove 154, such that the shaft 150 may be fixed to the lower thrust member 140. That is, the spindle motor 100 according to an exemplary embodiment of the present disclosure may have a fixed shaft structure in which the shaft 150 is fixed.

Meanwhile, the shaft 150 may form the bearing clearance B1 in which the lubricating fluid is filled, together with the rotating member 160. Further, the flange part 152 of the shaft 150 may forma sealing part 106 at which a liquid-vapor interface F2 is formed, together with the rotating member 160.

In addition, the flange part 152 may be inserted into an insertion groove 161 of the rotating member 160.

The rotor 120 may form the bearing clearance B1 in which the lubricating fluid is filled, together with the stator 110. In addition, the rotor 120 may include the rotating member 160 and a cap member 170.

The rotating member 160 may rotate around the shaft 150. In addition, the rotating member 160 may be provided with the insertion groove 161 into which the flange part 152 of the shaft 150 is inserted.

Meanwhile, the rotating member 160 may include a sleeve 162 forming the bearing clearance B1 in which the lubricating fluid is filled, together with the lower thrust member 140 and the shaft 150, and a rotor hub 164 extended from the sleeve 162.

Here, terms with respect to directions will be defined. As viewed in FIG. 1, an axial direction refers to a vertical direction, that is, a direction from the lower end portion of the shaft 150 toward the upper end portion thereof or a direction from the upper end portion of the shaft 150 toward the lower end portion thereof, and a radial direction refers to a horizontal direction, that is, a direction from the shaft 150 toward an outer peripheral surface of the rotor hub 164 or from the outer peripheral surface of the rotor hub 164 toward shaft 150.

Meanwhile, a circumferential direction refers to a rotation direction along outer peripheral surfaces of the shaft 150 and the rotor hub 154.

The sleeve 162 may be disposed between the flange part 152 of the shaft 150 and the lower thrust member 140, and may form the bearing clearance B1, together with the shaft 150 and the lower thrust member 140. Meanwhile, the sleeve 164 may be provided with a shaft hole 162a through which the shaft 150 penetrates.

In addition, upper and lower radial dynamic grooves (not shown) may be formed in at least one of an inner peripheral surface of the sleeve 162 and an outer peripheral surface of the shaft 150. The upper and lower radial dynamic grooves may be disposed to be spaced apart from each other by a predetermined interval in the axial direction, and may generate fluid dynamic pressure in the radial direction at the time of rotation of the sleeve 162 to allow the rotating member 160 to more stably rotate.

Meanwhile, the upper and lower radial dynamic grooves may have a herringbone shape by way of example.

In addition, the sleeve 162 may have a circulation hole 162b formed therein in order to connect the bearing clearance B1 formed by an upper surface of the sleeve 162 and the flange part 152 of the shaft 150 and the bearing clearance B1 formed by a lower surface of the sleeve 162 and the upper surface of the disk part 142 to each other. Meanwhile, the circulation hole 162b may have a chamfer 162c formed at a lower end portion thereof.

Meanwhile, the circulation hole 162b may serve to allow air bubbles contained in the lubricating fluid to be disposed. That is, the circulation hole 162b may serve to allow the air bubbles contained in the lubricating fluid to move to the sealing part 105.

In addition, as shown in FIG. 3, a portion of the bearing clearance B1 connected to one end portion of the circulation hole 162b and disposed at an outer side of the circulation hole 162b in the radial direction may have a width allowing an amount of force applied to the other side of the air bubble to be less than an amount of force applied to one side of the air bubble when one side of the air bubble is disposed at the circulation hole 162b and the other side thereof is disposed at a portion of the bearing clearance connected to the circulation hole 162b.

Further, in a portion of the bearing clearance B1 disposed adjacently to one end of the circulation hole 162b, a width of a portion of the bearing clearance B1 disposed on an inner side of the circulation hole 162b in the radial direction may be smaller than that of the portion of the bearing clearance B1 disposed at the outer side of the circulation hole 162b in the radial direction.

Further, as an example, the bearing clearance B1 connected to the circulation hole 162b may be tapered. That is, the bearing clearance B1 formed by the lower surface of the sleeve 162 and the upper surface of the disk part 142 may be tapered.

In more detail, as shown in FIG. 3, in the case in which air bubbles having a size larger than a diameter of the circulation hole 162b is confined in the circulation hole 162b, a width h of the bearing clearance B1 may be formed so that pressure P1 applied to one end of the air bubble disposed in the circulation hole 162b is larger than pressure P2 applied to the other end of the air bubble disposed in the bearing clearance B1.

That is, the width h of the bearing clearance B1 disposed at the outer side of the circulation hole 162b in the radial direction may be enough to allow the air bubbles to move from the bearing clearance B1 in the outer diameter direction in the case in which the air bubbles having the size larger than the diameter of the circulation hole 162b are introduced into the circulation hole 162b.

In more detail, the width h of the bearing clearance b1 disposed at the outer side of the circulation hole 162b in the radial direction may satisfy the following Conditional Expression:

$$h \geq \frac{- b + \sqrt{{b}^{2} - 4 a c}}{a}$$

$$a = 2 ( 1 - sin θ )$$

$$b = 2 {r}_{2} cos θ - {r}_{1} ( 2 - sin θ )$$

$$c = - {r}_{1} {r}_{2} cos θ$$

Here, h refers to the width of the portion of the bearing clearance disposed at the outer side of the circulation hole in the radial direction in the portion of the bearing clearance disposed adjacently to one end of the circulation hole, r₁ is a radius of the circulation hole, r₂ is a radius at a distal end of a chamfer, and θ indicates an angle of contact between a portion contacting the lubricating fluid and the lubricating fluid.

Further, in the bearing clearance B1 formed by the lower surface of the sleeve 162 and the upper surface of the disk part 142, a width of the portion disposed on the inner side of the circulation hole 162b in the radial direction based on the circulation hole 162b may be wider than that of the portion disposed at the outer side of the circulation hole 162b in the radial direction.

In the case in which the width of the bearing clearance B1 formed by the lower surface of the sleeve 162 and the upper surface of the disk part 142 is set as described above, even though the air bubbles having the size larger than the diameter of the circulation hole 162b are introduced into the circulation hole 162b, the air bubbles may more smoothly move to the sealing part 105.

Therefore, the air bubbles may be more smoothly discharged to the outside.

The rotor hub 164 may be extended from the sleeve 162 as shown in more detail in FIG. 1. Meanwhile, although the case in which the sleeve 162 and the rotor hub 164 are formed integrally with each other has been described by way of example in the present exemplary embodiment, the present disclosure is not limited thereto. That is, the rotor hub 164 and the sleeve 162 may be manufactured separately from each other and be then assembled to each other.

In addition, the rotor hub 164 may include a body 164a having a disk shape, a magnet mounting part 164b extended from an edge of the body 146a in a downward axial direction, and a disk support part 164c extended from a distal end of the magnet mounting part 164b in the radial direction.

In addition, the magnet mounting part 164b may have a driving magnet 164d fixedly installed on an inner surface thereof. Therefore, an inner surface of the driving magnet 164d may be disposed to face the stator core 102.

Here, a rotational driving scheme of the rotating member 160 will be briefly described. When power is supplied to a coil 104 wound around the stator core 102, driving force capable of rotating the rotating member 160 may be generated by an electromagnetic interaction between the stator core 102 having the coil 104 wound therearound and the driving magnet 164d to rotate the rotating member 160.

That is, the driving magnet 164d and the stator core 102 disposed to face the driving magnet 164d and having the coil 104 wound therearound may electromagnetically interact with each other to rotate the rotating member 160.

In addition, the body 164a may have an installation protrusion 164e protruding in the upward axial direction on an upper surface thereof. A cap member 170 may be installed in the installation protrusion 164e in order to prevent scattering of the lubricating fluid due to the leakage of the lubricating fluid.

The cap member 170 may have a disk shape and rotate together with the rotating member 160. In addition, the cap member 170 may be bonded to the rotating member 160 by at least one of an adhesion method and a welding method.

As described above, even though the air bubbles having the size larger than the diameter of the circulation hole 162b are introduced into the circulation hole 162b, the air bubbles may more smoothly move to the sealing part 105. Therefore, the air bubbles may be more smoothly discharged to the outside.

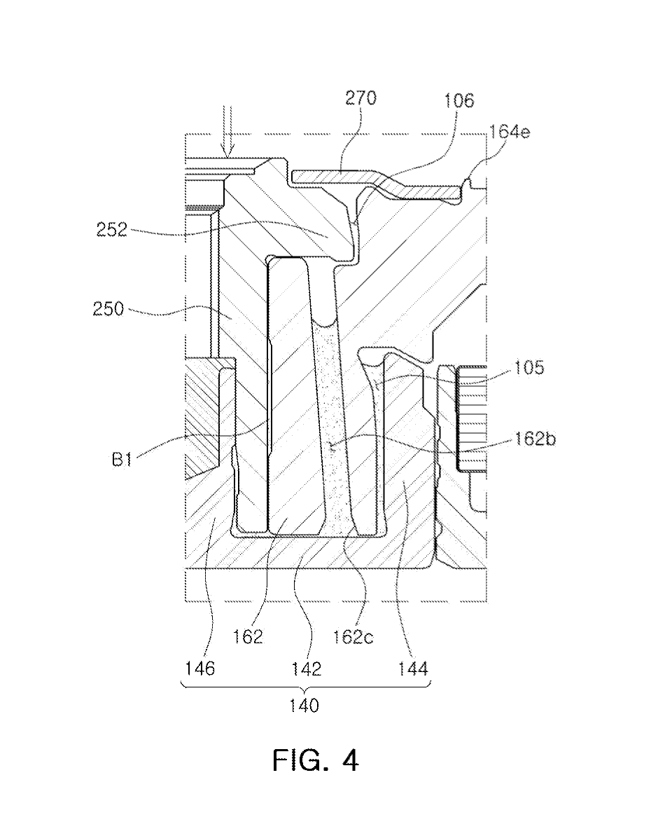

Hereinafter, an operation of the spindle motor according to an exemplary embodiment of the present disclosure will be described with reference to FIGS. 4 through 7.

FIGS. 4 through 7 are views for describing an operation of the spindle motor according to an exemplary embodiment of the present disclosure.

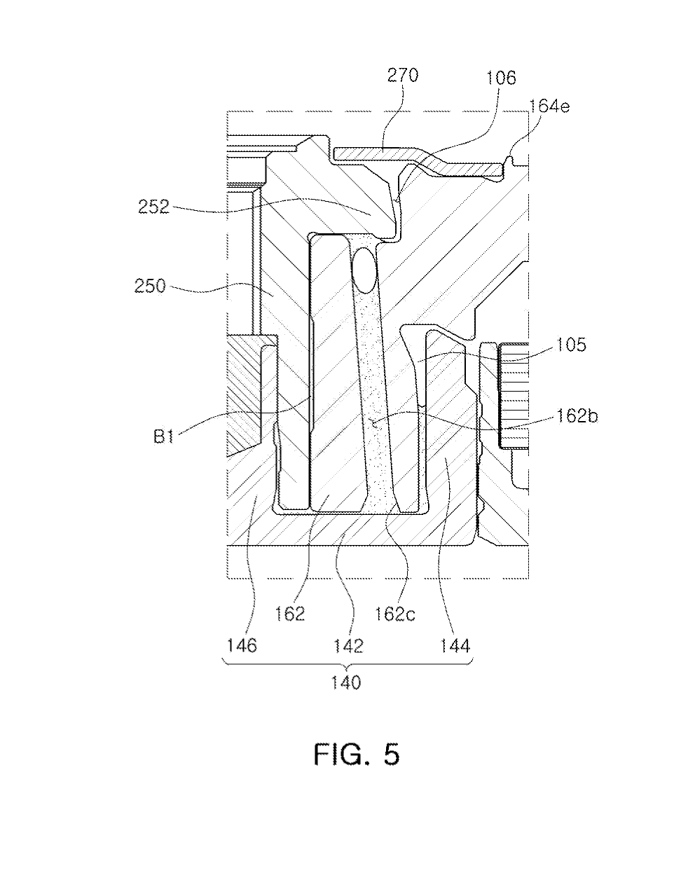

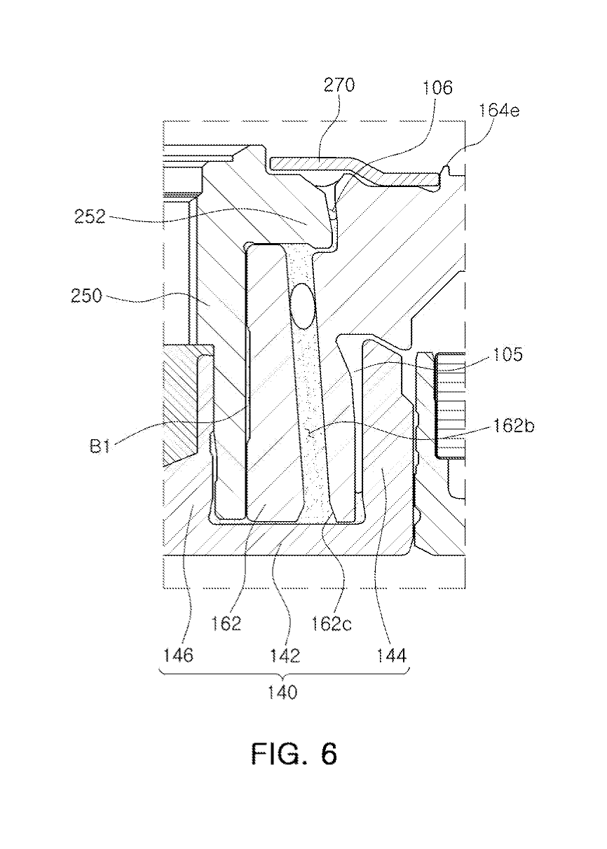

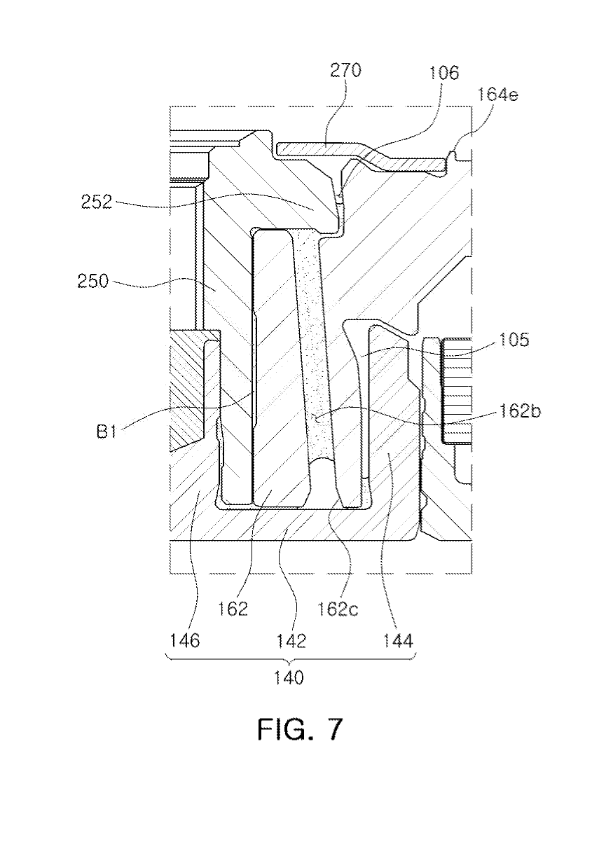

That is, FIG. 4 is a view showing a state in which the lubricating fluid moves in the case in which external impact is applied to the spindle motor; FIG. 5 is a view showing a state in which the air bubbles are introduced in the bearing clearance; FIG. 6 is a view showing a state in which the air bubbles move within the bearing clearance; and FIG. 7 is a view showing a state in which the air bubbles are discharged from the bearing clearance to the outside.

Referring to FIG. 4, in the case in which external impact is applied to the spindle motor from the top in the axial direction, the lubricating fluid in the bearing clearance B1 may move. In this case, the lubricating fluid may move so that the liquid-vapor interface F2 is disposed in the circulation hole 162b.

Then, the lubricating fluid may again move from the bearing clearance B1 in an upward direction. In this case, as shown in FIG. 5, the air bubbles having the size larger than the diameter of the circulation hole 162b may be disposed in the circulation hole 162b.

Then, the air bubbles may move to the lower end portion of the circulation hole 162b, as shown in FIG. 6, depending on the circulation of the lubricating fluid.

However, as shown in FIG. 3, in the case in which the air bubbles having the size larger than the diameter of the circulation hole 162b are disposed at the lower end portion of the circulation hole 162b, the width h of the bearing clearance B1 may be formed so that the pressure P1 applied to one end of the air bubble disposed in the circulation hole 162b is larger than the pressure P2 applied to the other end of the air bubble disposed in the bearing clearance B1.

That is, the width h of the bearing clearance B1 disposed at the outer side of the circulation hole 162b in the radial direction may be enough to allow the air bubbles to move from the bearing clearance B1 in the outer diameter direction in the case in which the air bubbles having the size larger than the diameter of the circulation hole 162b are introduced into the circulation hole 162b.

In more detail, the width h of the bearing clearance B1 disposed at the outer side of the circulation hole 162b in the radial direction may satisfy the following Conditional Expression:

$$h \geq \frac{- b + \sqrt{{b}^{2} - 4 a c}}{a}$$

$$a = 2 ( 1 - sin θ )$$

$$b = 2 {r}_{2} cos θ - {r}_{1} ( 2 - sin θ )$$

$$c = - {r}_{1} {r}_{2} cos θ$$

Here, h refers to the width of the portion of the bearing clearance disposed at the outer side of the circulation hole in the radial direction in the portion of the bearing clearance disposed adjacently to one end of the circulation hole, r₁ is a radius of the circulation hole, r₂ is a radius at a distal end of a chamfer, and θ indicates an angle of contact between a portion contacting the lubricating fluid and the lubricating fluid.

Further, in the bearing clearance B1 formed by the lower surface of the sleeve 162 and the upper surface of the disk part 142, a width of the portion disposed on the inner side of the circulation hole 162b in the radial direction based on the circulation hole 162b may be wider than that of the portion disposed at the outer side of the circulation hole 162b in the radial direction.

In the case in which the width of the bearing clearance B1 formed by the lower surface of the sleeve 162 and the upper surface of the disk part 142 is set as described above, even though the air bubbles having the size larger than the diameter of the circulation hole 162b are introduced into the circulation hole 162b, the air bubbles may more smoothly move to the sealing part 105, as shown in FIG. 7.

Therefore, the air bubbles may be more smoothly discharged to the outside.

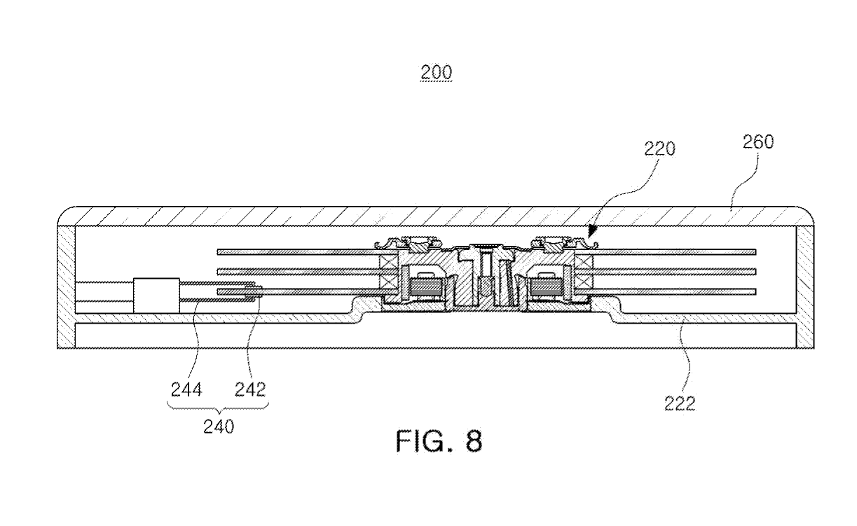

FIG. 8 is a schematic cross-sectional view showing a hard disk drive according to an exemplary embodiment of the present disclosure.

Referring to FIG. 8, a hard disk drive 200 according to an exemplary embodiment of the present disclosure may include a spindle motor 220, a head transfer part 240, and an upper case 260 by way of example.

The spindle motor 220 may have a recording disk D mounted thereon.

The head transfer part 240 may transfer a head 242 reading information from the recording disk D mounted on the spindle motor 220 to a surface of the recording disk D from which the information is to be read. The head 242 may be disposed on a support part 244 of the head transfer part 240.

The upper case 260 may be assembled to a base member 222 in order to form an internal space accommodating the spindle motor 220 and the head transfer part 240 therein.

As set forth above, according to exemplary embodiments of the present disclosure, the air bubbles may be easily discharged.

While exemplary embodiments have been shown and described above, it will be apparent to those skilled in the art that modifications and variations could be made without departing from the scope of the present invention as defined by the appended claims.

What is claimed is:

1. A spindle motor comprising:
a stator; and
a rotor forming a bearing clearance filled with a lubricating fluid, together with the stator,
wherein at least one of the rotor and the stator is provided with a circulation hole through which air bubbles contained in the lubricating fluid are discharged, and
a portion of the bearing clearance, connected to one end portion of the circulation hole, and disposed at an outer side of the circulation hole in a radial direction, has a width allowing an amount of force applied to the other side of the air bubble to be less than an amount of force applied to one side of the air bubble when one side of the air bubble is disposed in the circulation hole and the other side of the air bubble is disposed in the portion of the bearing clearance connected to the circulation hole.

2. The spindle motor of claim 1, wherein the bearing clearance connected to the circulation hole is tapered.

3. The spindle motor of claim 2, wherein in a portion of the bearing clearance disposed adjacently to one end of the circulation hole, a width of a portion of the bearing clearance disposed on an inner side of the circulation hole in the radial direction is smaller than that of the portion of the bearing clearance disposed on the outer side of the circulation hole in the radial direction.

4. The spindle motor of claim 1, wherein the circulation hole has a chamber formed in one end portion of the circulation hole.

5. The spindle motor of claim 4, wherein a width of the portion of the bearing clearance disposed on the outer side of the circulation hole in the radial direction in a portion of the bearing clearance disposed adjacently to one end of the circulation hole satisfies the following Conditional Expression:
$$h \geq \frac{- b + \sqrt{{b}^{2} - 4 a c}}{a}$$
$$a = 2 ( 1 - sin θ )$$
$$b = 2 {r}_{2} cos θ - {r}_{1} ( 2 - sin θ )$$
$$c = - {r}_{1} {r}_{2} cos θ ,$$
where h is the width of the portion of the bearing clearance disposed on the outer side of the circulation hole in the radial direction in the portion of the bearing clearance disposed adjacently to one end of the circulation hole, r₁ is a radius of the circulation hole, r₂ is a radius at a distal end of the chamfer, and θ indicates an angle of contact between a portion of the bearing clearance contacting the lubricating fluid and the lubricating fluid.

6. The spindle motor of claim 1, wherein the stator includes a base member, a lower thrust member fixed to the base member, and a shaft fixed to the lower thrust member.

7. The spindle motor of claim 6, wherein the rotor includes a sleeve forming the bearing clearance together with the lower thrust member and the shaft.

8. The spindle motor of claim 7, wherein the circulation hole is formed to be inclined in the sleeve, and a chamfer formed in the circulation hole is disposed at a lower end portion of the sleeve.

9. The spindle motor of claim 7, wherein an upper surface of the lower thrust member is inclined.

10. A hard disk drive comprising:
the spindle motor of claim 1 rotating a recording disk;
a head transfer part transferring a head reading information from the recording disk mounted on the spindle motor to the recording disk; and
an upper case coupled to a base member provided in the spindle motor to form an internal space accommodating the spindle motor and the head transfer part.
